(19) United States
(12) Patent Application Publication
(10) Pub. No.: US 2015/0146224 A1
(43) Pub. Date: May 28, 2015

(54) IMAGE PROCESSING APPARATUS AND IMAGE PROCESSING METHOD

(71) Applicant: CANON KABUSHIKI KAISHA, Tokyo (JP)

(72) Inventors: Koya Shimamura, Kawasaki-shi (JP); Naoki Ito, Tokyo (JP)

(21) Appl. No.: 14/535,824

(22) Filed: Nov. 7, 2014

(30) Foreign Application Priority Data
Nov. 22, 2013 (JP) 2013-242152

(51) Int. Cl. H04N 1/387; H04N 1/46; H04N 1/60; H04N 1/00

(52) U.S. Cl. CPC H04N 1/3871; H04N 1/00251; H04N 1/00005; H04N 1/00018; H04N 1/00082; H04N 1/46; H04N 1/60; H04N 2201/0094; H04N 2201/0081; H04N 2201/0084
USPC 358/1.13

(57) ABSTRACT

In a case where an image and another image are integrated into one file, brightness, dynamic ranges, etc., of the images are different from each other. Consequently, an image processing apparatus obtains first image information indicative of characteristics of a first image obtained from a first device and second image information indicative of characteristics of a second image obtained from a second device that is a device different from the first device. Then, the first image is corrected based on the first image information and the second image information. The first image that is corrected and the second image are combined.

### BACKGROUND OF THE INVENTION

1. Field of the Invention

The present invention relates to an image processing apparatus and an image processing method, and for example, to an image processing apparatus and an image processing method for integrating a document image obtained by a first image obtaining apparatus, such as a scanner, and a document image obtained by a second image obtaining apparatus, such as a camera, as the same file.

2. Description of the Related Art

Transmitting data generated by an apparatus to another apparatus is performed. For example, processing to transmit/transfer document data generated by text creating software of a personal computer (PC) to another PC is performed. Further, scanning a photo image or a document image printed on a paper medium by an MFP having a scanner device or a document scanner, converting the scanned image into the JPEG, TIFF, or PDF format, and transmitting the converted image to a PC by the electronic mail function etc. are performed. In recent years, converting an image captured by a mobile terminal, such as a smart phone or a tablet, into, for example, the JPEG format and transmitting the converted image to a PC from the mobile terminal by the electronic mail function etc. have also begun to be performed. The performance of the camera function of a mobile terminal has been improved and it is made possible to obtain not only a natural image but also an image equivalent to that obtained by a scanner by capturing an image of document text and by performing geometric correction or color correction.

Japanese Patent Laid-Open No. 2013-29934 has disclosed a technique to combine all or two kinds of pieces of digital data obtained by bitmapping the above-described document data or image data to integrate the pieces of data into one piece of data.

Further, Japanese Patent Laid-Open No. 2001-292300 has disclosed a technique to replace part of an image read by a scan with a specific image. For example, creating one document by replacing part of an application form scanned in advance with an image captured in advance by making use of such the technique as disclosed in Japanese Patent Laid-Open No. 2001-292300 is also thought of.

However, in a case where an image and another image are integrated into one file, if images obtained by different devices are directly combined or inserted, there is such a problem that brightness, dynamic range, and the like, are different from each other.

### SUMMARY OF THE INVENTION

An image processing apparatus according to the present invention has an obtaining unit configured to obtain first image information indicative of characteristics of a first image obtained from a first device and second image information indicative of characteristics of a second image obtained from a second device that is a device different from the first device, a correction unit configured to correct the first image based on the first image information and the second image information, and a combination unit configured to combine the first image corrected by the correction unit and the second image.

According to the present invention, it is made possible to match the dynamic range, color tone, or base color in a case where images obtained by different devices are combined or inserted.

Further features of the present invention will become apparent from the following description of exemplary embodiments (with reference to the attached drawings).

### BRIEF DESCRIPTION OF THE DRAWINGS

FIG. 1 is a diagram showing an example of a system in an embodiment of the present invention;

FIG. 2 is a block diagram showing a configuration example of an image forming apparatus in the embodiment of the present invention;

FIG. 3 is a block diagram showing a configuration example of a cloud service server in the embodiment of the present invention;

FIG. 4 is a block diagram showing a configuration example of a mobile terminal in the embodiment of the present invention;

FIG. 5 is a diagram showing a software configuration example of the image forming apparatus in the embodiment of the present invention;

FIG. 6 is a diagram showing a software configuration example of the mobile terminal in the embodiment of the present invention;

FIG. 7 is a diagram showing a software configuration example of the cloud service server in the embodiment of the present invention;

FIG. 8 is a diagram showing an example of a sequence from scan processing, image processing to screen display processing in the embodiment of the present invention;

FIG. 9A to FIG. 9C are diagrams showing an example of a document used in a scan and image capturing in the embodiment of the present invention;

FIG. 10 is a flowchart showing an example of a configuration for obtaining image information in the embodiment of the present invention;

FIG. 11 is a diagram showing an example of a flowchart for correcting an image in the embodiment of the present invention;

FIG. 12A and FIG. 12B are image diagrams showing contents of image processing in the embodiment of the present invention;

FIG. 13 is an image diagram showing contents in the embodiment of the present invention;

FIG. 14 is a flowchart showing an example of a configuration for obtaining image information in the embodiment of the present invention;

FIG. 15A and FIG. 15B are diagrams showing an example of a device difference database in the embodiment of the present invention;

FIG. 16 is a flowchart showing an example of image correction processing in the embodiment of the present invention;

FIG. 17 is a block diagram showing a configuration example of the cloud service server in the embodiment of the present invention;

FIG. 18 is an image diagram showing contents in the embodiment of the present invention; and

FIG. 19 is a flowchart showing an example of image correction processing in the embodiment of the present invention.

### DESCRIPTION OF THE EMBODIMENTS

Hereinafter, embodiments according to the present invention are explained in detail by using the drawings. However, components described in the embodiments are only illustrative and are not intended to limit the scope of the present invention to those embodiments.

### First Embodiment

In a first embodiment, a paper document is scanned by a scan terminal and a scanned image is generated. Further, a captured image is generated by using the camera function of a mobile terminal. Then, image processing to integrate the scanned image and the captured image within a server is explained.

### <System Configuration>

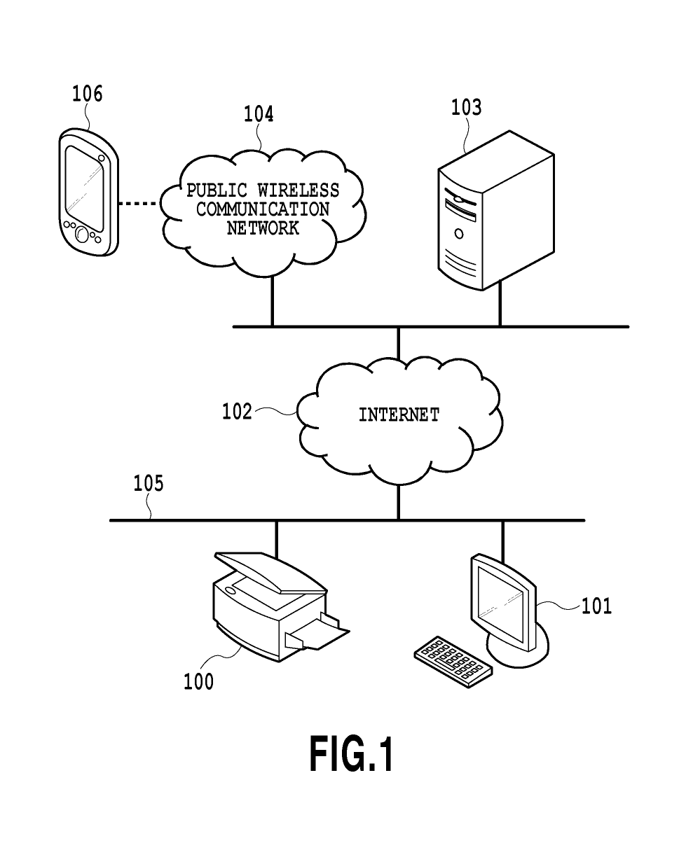

FIG. 1 is a diagram showing an example of the entire configuration of a system in the first embodiment. As shown in FIG. 1, the system in the first embodiment has an image forming apparatus 100, a PC 101, a cloud service server 103, and a mobile terminal 106. The image forming apparatus 100 and the PC 101 are connected to a LAN 105 including the Ethernet (registered trademark), a wireless LAN or the like, and are then connected to an Internet 102.

The cloud service server 103 is connected to the LAN 105 including the Ethernet (registered trademark), a wireless LAN or the like, and then is connected to the Internet 102. The mobile terminal 106 is connected to the Internet 102 through a public wireless communication network 104 etc. The image forming apparatus 100, the PC 101, the cloud service server 103, and the mobile terminal 106 are connected to the Internet 102 through the LAN 105 or the public wireless communication network 104 and are able to communicate with one another.

The image forming apparatus 100 is a multifunction peripheral (MFP) having an operation unit, a scanner unit, and a printer unit. In the system of the present embodiment, the image forming apparatus 100 is utilized as a scan terminal of a paper document. It is possible to refer to the image forming apparatus 100 as a first image obtaining apparatus. Further, it is also possible to refer to a scanned image obtained by the image forming apparatus 100 as a first image.

The mobile terminal 106 is a smart phone or a tablet terminal having an operation unit, a camera unit, and a wireless communication unit. In the system of the present embodiment, the mobile terminal 106 is utilized for checking the image data of a scanned paper document. Further, the mobile terminal 106 is also utilized as an image capturing terminal for generating a captured image by capturing an image of a paper document or a natural image. It is also possible to refer to the mobile terminal 106 as a second image obtaining apparatus. Further, it is also possible to refer to a captured image obtained by the mobile terminal 106 as a second image.

### <Hardware Configuration of Image Forming Apparatus 100>

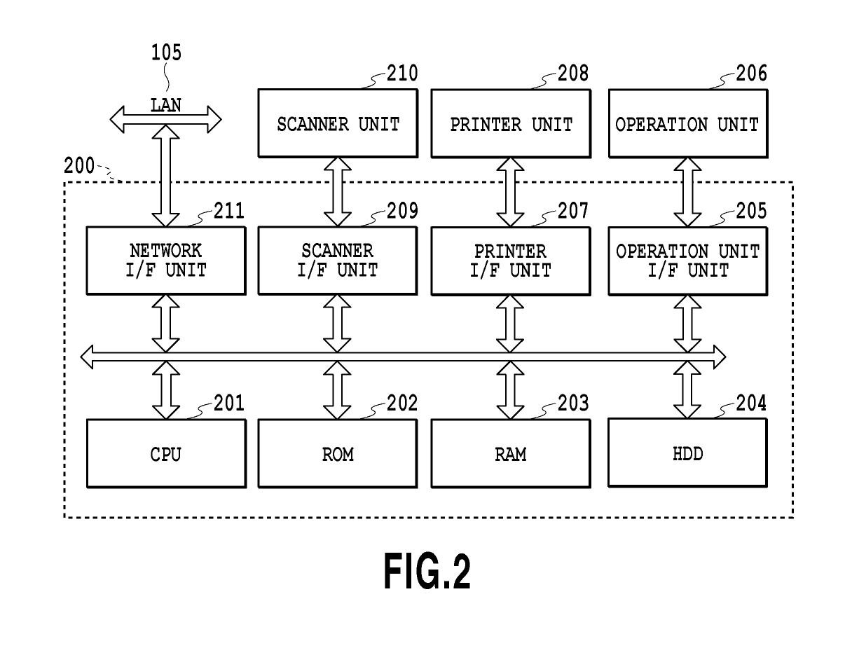

FIG. 2 is a block diagram showing an example of a configuration of the image forming apparatus 100. A control unit 200 including a CPU 201 controls the operation of the entire image forming apparatus 100. The CPU 201 reads control programs stored in a ROM 202 and performs various kinds of control, such as read control and transmission control. A RAM 203 is used as a main memory or a temporary storage area, such as a work area, of the CPU 201.

An HDD 204 stores image data and various kinds of programs. An operation unit I/F unit 205 connects an operation unit 206 and the control unit 200. The operation unit 206 includes a liquid crystal display unit having a touch panel function, a keyboard, etc. A printer I/F unit 207 connects a printer unit 208 and the control unit 200. Image data to be printed in the printer unit 208 is transferred from the control unit 200 via the printer I/F unit 207 and in the printer unit 208, an image is printed on a recording medium.

A scanner I/F unit 209 connects a scanner unit 210 and the control unit 200. The scanner unit 210 reads an image on a document and generates image data and inputs the image data to the control unit 200 via the scanner I/F unit 209.

A network I/F unit 211 connects the control unit 200 (image forming apparatus 100) to the LAN 105. The network I/F unit 211 performs transmission of image data and information to an external apparatus (e.g., cloud service server 103) on the LAN 105, reception of various kinds of information from an external apparatus on the LAN 105, and so on.

### <Hardware Configuration of Cloud Service Server 103>

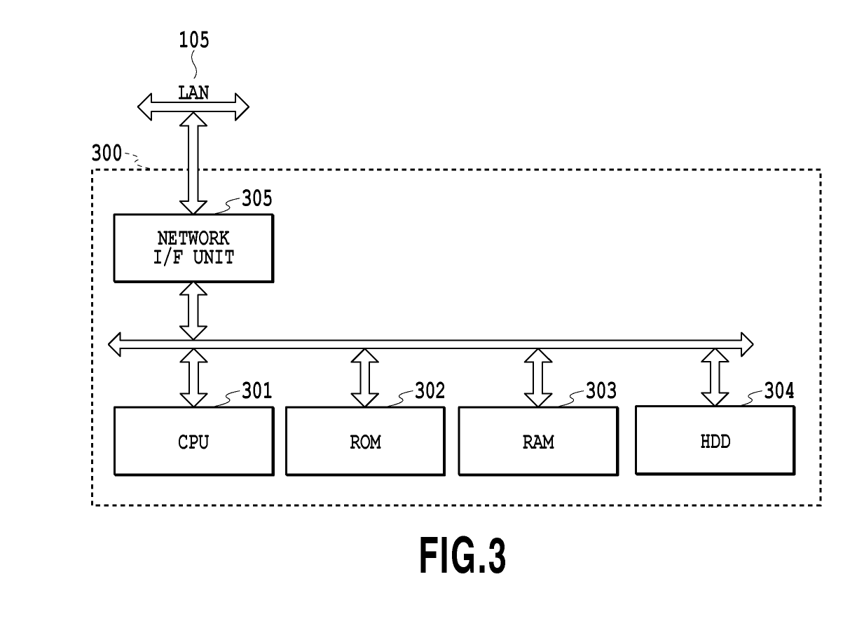

FIG. 3 is a block diagram showing an example of a configuration of the cloud service server 103. A control unit 300 including a CPU 301 controls the operation of the entire cloud service server 103. The CPU 301 reads control programs stored in a ROM 302 and performs various kinds of control processing. A RAM 303 is used as a main memory and a temporary storage area, such a work area, of the CPU 301. An HDD 304 stores image data, various kinds of programs, and various kinds of information tables, to be described later.

A network I/F unit 305 connects the control unit 300 (cloud service server 103) to the LAN 105. The network I/F unit 305 transmits and receives various kinds of information to and from another apparatus on the LAN 105.

<Hardware configuration of mobile terminal 106>

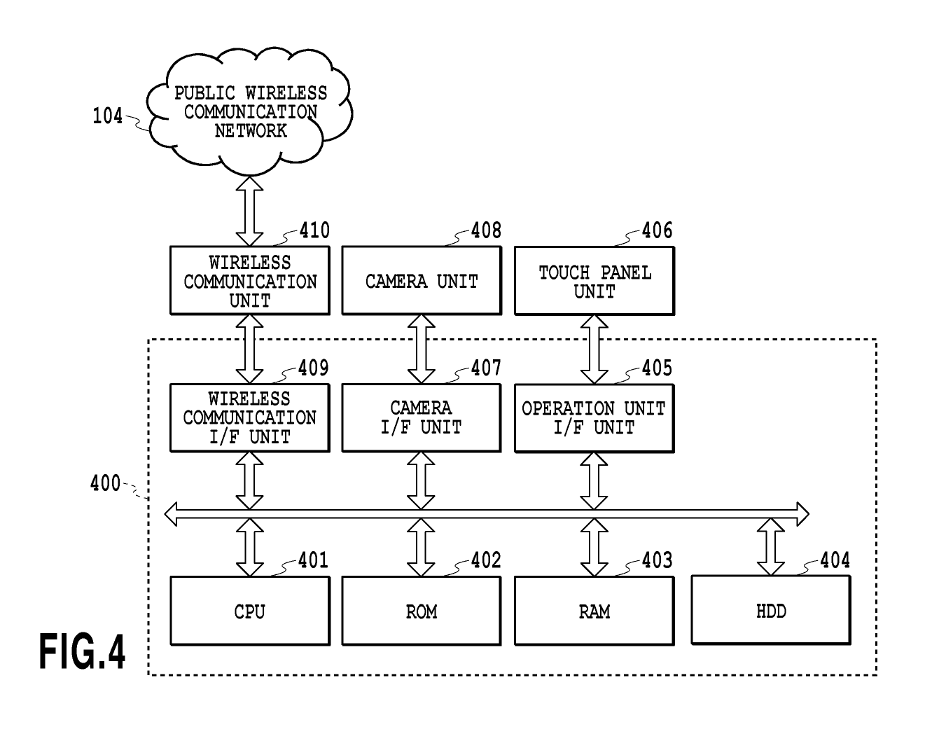

FIG. 4 is a block diagram showing an example of a hardware configuration of the mobile terminal 106, such as a smart phone and a tablet terminal.

A control unit 400 including a CPU 401 controls the operation of the entire mobile terminal 106. In FIG. 4, the CPU 401, a ROM 402, a RAM 403, an HDD 404, an operation unit I/F unit 405, a camera I/F unit 407, and a wireless communication I/F unit 409 included in the control unit 400 are connected via a system bus so as to be capable of communicating with one another.

The CPU 401 is a central processing unit and comprehensively performs control based on programs etc. stored in the ROM 402. Further, the CPU 401 performs communication to control a touch panel unit 406 and a camera unit 408 connected via the operation unit I/F unit 405 and the camera I/F unit 407. The ROM 402 is a nonvolatile flash memory and stores various kinds of programs and data. Further, the ROM 402 is utilized as a storage area of an electronic file. The RAM 403 is utilized as a work area at the time of the execution of a program.

The operation unit I/F unit 405 is for connecting the control unit 400 and the touch panel unit 406. It is possible for the touch panel unit 406 to process information on a number of simultaneously touched points including processing data related to the pressure and the magnitude of the touch and the position of each touched point. Further, the touch panel unit 406 is an input apparatus and also functions as a display apparatus that produces a display to a user.

The camera unit 408 is hardware including a camera lens and a sensor for capturing an image. The wireless communication I/F unit 409 is for connecting the control unit 400 and a wireless communication unit 410. The wireless communication unit 410 is hardware for performing wireless communication. The wireless communication unit 410 connects with the public wireless communication network 104. The wireless communication unit 410 transmits and receives various kinds of information to and from another apparatus on the public wireless communication network 104. Further, the wireless communication unit 410 performs transmission, reception, and so on, of images etc. captured by the camera unit 408 with an external apparatus (e.g., cloud service server 103) on the public wireless communication network 104 or the LAN 105.

### <Software Configuration of Image Forming Apparatus 100>

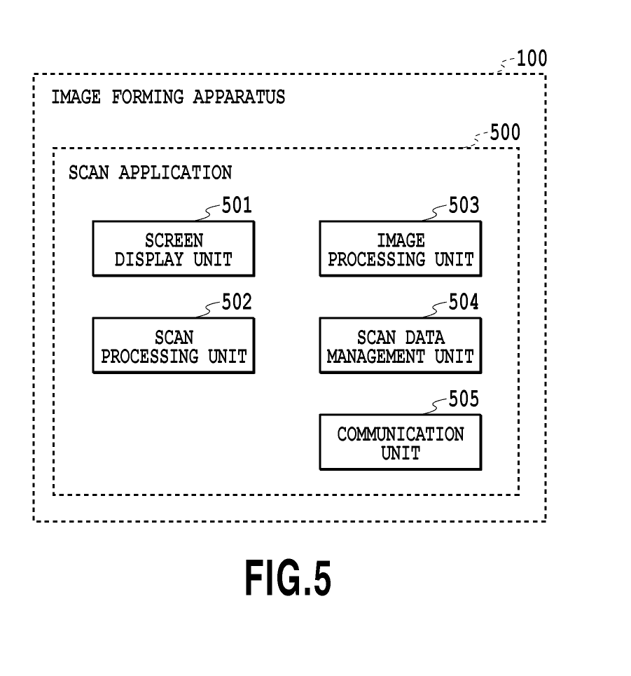

FIG. 5 is a diagram showing an example of a configuration of software modules of the image forming apparatus 100 related to scan processing in the present embodiment. These software modules are stored in the HDD 204 of the image forming apparatus 100 and are executed by the CPU 201.

A scan application 500 is a software module for transmitting a scanned image to the cloud service server 103. The scan application includes a screen display unit 501, a scan processing unit 502, an image processing unit 503, a scan data management unit 504, and a communication unit 505.

The screen display unit 501 is a software module for producing a display for performing scan processing on the operation unit 206 via the operation unit I/F unit 205.

The scan processing unit 502 is a software module for performing processing to read a paper document by driving the scanner unit 210 via the scanner I/F unit 209. The scan processing unit 502 receives image data from the scanner unit 210 and saves the image data in the HDD 204.

The image processing unit 503 is a software module for converting image data saved in the HDD 204 into an image format, such as JPEG. Further, it is also possible for the image processing unit 503 to perform image processing, such as edge enhancement processing and color adjustment processing, on image data obtained by the scanner unit 210.

The scan data management unit 504 is a software module for saving image data converted into an image format, such as JPEG, by the image processing unit 503 in the HDD 204 and for managing the image data as an scanned image. In the present embodiment, image data obtained and managed by the scan application 500 is referred to as a scanned image.

The communication unit 505 is a software module for registering a scanned image saved in the HDD 204 to the cloud service server 103 via the network I/F unit 211.

In the present embodiment, the software configuration of the image forming apparatus 100 as in FIG. 5 is introduced, but the configuration is not limited to that in FIG. 5 as long as the configuration is a system in which a scanned image can be obtained by a scanner etc. and the scanned image can be transferred.

### <Software Configuration of Mobile Terminal 106>

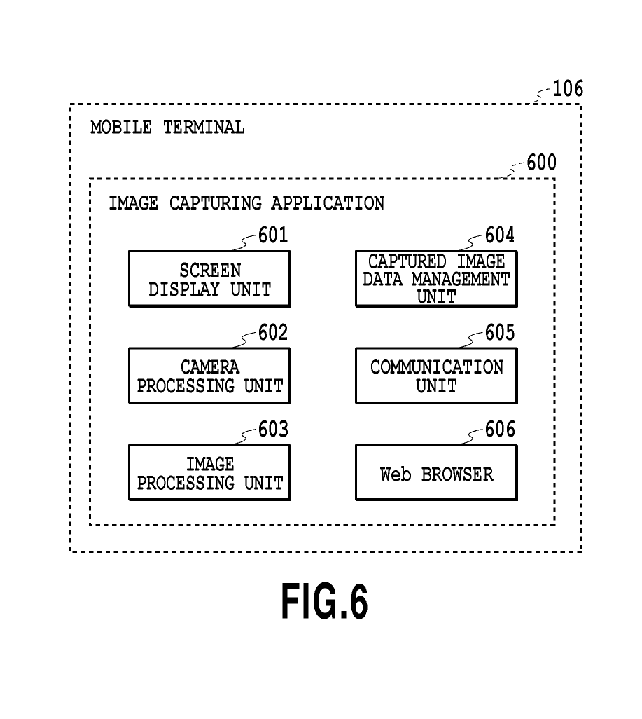

FIG. 6 is a diagram showing an example of a configuration of software modules of the mobile terminal 106 related to image capturing processing in the present embodiment. These software modules are stored in the HDD 404 of the mobile terminal 106 and are executed by the CPU 401.

An image capturing application 600 is a software module for transmitting an image captured by a camera to the cloud service server 103. The image capturing application 600 includes a screen display unit 601, a camera processing unit 602, an image processing unit 603, a captured image data management unit 604, a communication unit 605, and a Web browser 606.

The screen display unit 601 is a software module for performing image capturing processing via the operation unit I/F unit 405 and producing a display for checking a captured image on the touch panel unit 406.

The camera processing unit 602 is a software module for performing processing to capture an image of a paper document, a natural image, an image of a landscape, etc., to obtain a captured image by driving the camera unit 408 via the camera I/F unit 407. The camera processing unit 602 receives image data from the camera unit 408 and saves the image data in the HDD 404.

The image processing unit 603 is a software module for converting image data saved in the HDD 404 into an image format, such as JPEG. Further, it is also possible for the image processing unit 603 to perform image processing, such as edge enhancement processing and color adjustment processing, on an image captured by a camera.

The captured image data management unit 604 is a software module for saving image data converted into an image format, such as JPEG, by the image processing unit 603 in the HDD 404 and for managing the image data as a captured image. In the present embodiment, image data captured and managed by the image capturing application 600 is referred to as a captured image.

The communication unit 605 is a software module for transmitting a captured image saved in the HDD 404 to the cloud service server 103 via the wireless communication I/F unit 409.

The Web browser 606 is a software module for performing communication by the HTTP protocol with the cloud service server 103 and for displaying received HTML data and receiving an input from a user. By the Web browser 606, for example, it is made possible for the browser to perform activation of the camera unit 408 and so on.

In the present embodiment, the above-described software configuration of the mobile terminal 106 is introduced, but the configuration is not limited to that described above as long as the configuration is a system in which a captured image can be obtained by a camera etc. and can be transferred.

### <Software Configuration of Cloud Service Server 103>

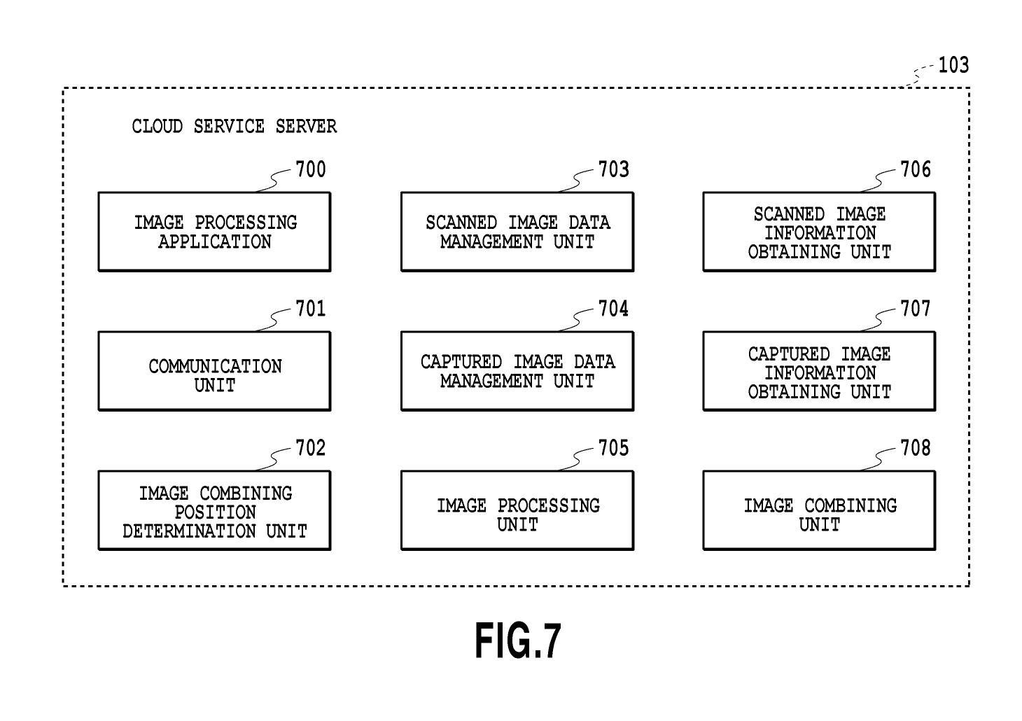

FIG. 7 is a diagram showing an example of a configuration of software modules related to image processing in the cloud service server 103 in the present embodiment. These software modules are stored in the HDD 304 of the cloud service server 103 and are executed by the CPU 301. The cloud service server 103 includes an image processing application 700, a communication unit 701, an image combining position determination unit 702, a scanned image data management unit 703, a captured image data management unit 704, and an image processing unit 705. Further, the cloud service server 103 includes a scanned image information obtaining unit 706, a captured image information obtaining unit 707, and an image combining unit 708.

Although detailed explanation will be given in the following, the contents of the comprehensive processing within the cloud service server 103 include image processing, such as processing to match the dynamic ranges between a scanned image obtained by the image forming apparatus 100 and a captured image obtained by the mobile terminal 106. In the case where the image processing is performed, the cloud service server 103 obtains image information, such as a histogram and a count of number of chromatic colors, from each image. Then, the cloud service server 103 performs correction of at least one of the scanned image and the captured image based on the obtained image information and combines the corrected image with the other image to form the same file. Combining images to form the same file means to form an image file (image data) indicating, for example, a combined image obtained by combining a scanned image and a captured image. Further, a PDF file into which a page of a scanned image and a page of a captured image are integrated may be formed.

The image processing application 700 is an application for causing the image processing unit 705 to perform image processing on an image sent via the Internet 102 on the cloud service server 103.

The communication unit 701 is a software module for receiving a scanned image or a captured image transmitted from another apparatus and saving the image in the HDD 304, and for performing transmission, reception, etc., of an integrated file saved in the HDD with another apparatus via the network I/F unit 305.

The image combining position determination unit 702 is a software module for determining a position where a captured image is inserted from among scanned images saved in the HDD 304 and for determining a position where a scanned image is inserted from among captured images.

The scanned image data management unit 703 is a software module for managing an intermediate product obtained by performing image processing on a scanned image and data of the image processing result.

The captured image data management unit 704 is a software module for managing an intermediate product obtained by performing image processing on a captured image and data of the image processing result.

The image processing unit 705 is a software module for performing image processing on a scanned image and a captured image in accordance with instructions of the image processing application 700.

The scanned image information obtaining unit 706 is a software module for obtaining image information, such as a histogram, from a scanned image.

The captured image information obtaining unit 707 is a software module for obtaining image information, such as a histogram, from a captured image.

The image combining unit 708 is a software module for combining a scanned image and a captured image processed in the image processing unit 705 and saved in the HDD 304 to form the same file.

### <Processing Sequence>

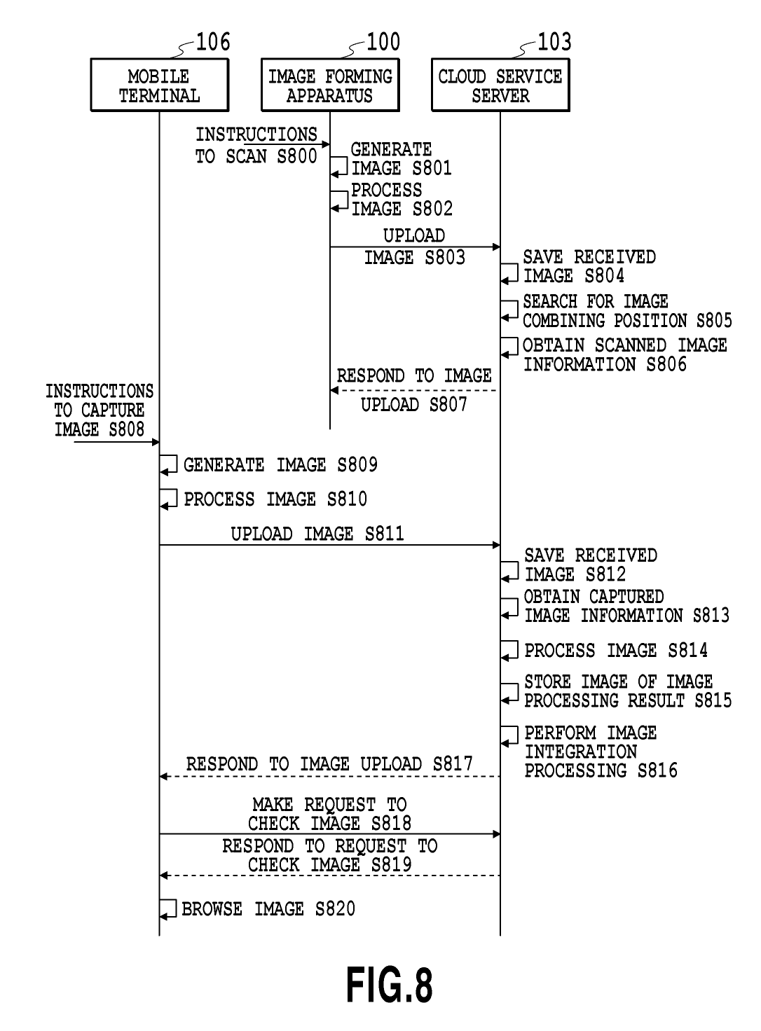

FIG. 8 is a diagram showing an example of a processing sequence in a case where a scanned image of a paper document obtained by the image forming apparatus and a captured image of a paper document obtained by the mobile terminal are integrated into the same file within the cloud service server 103. In the processing sequence shown in FIG. 8, an example is explained, in which the dynamic ranges etc. of images obtained from different devices are matched and correction is performed so that the documents have the same color tone, and then a scanned image and a captured image are combined. In the present embodiment, a case is explained, where a scanned image obtained by scanning a paper document by a multifunction peripheral etc. and a captured image obtained by capturing an image of a paper document by a camera are combined, but the combination is not limited to the above. For example, it is assumed that bitmapped PDL digital data generated by text creating software of a PC, scan data obtained by a scanner device, such as an MFP, and data of an image captured by the mobile terminal are used. In this case, it is also possible to apply the present embodiment to each piece of the data or to a case where all the pieces of data are combined.

In the present embodiment, in order to make explanation more specific, an example of a case where a user performs operations below is introduced. A user handles a variety of paper documents in operations. A case is thought of where a user pastes a scanned image of, for example, a receipt having an irregular size, onto an electronic application form obtained by scanning an application form printed on a regular size sheet, and then presents the electronic application form. As described above, in the case where, for example, a scanned image obtained by scanning an irregular size sheet is inserted into a scanned image obtained by scanning a regular size sheet, usually it is necessary to scan each sheet by a scanner and to perform insertion work after performing the work, such as trimming and size change by a PC etc. In the following, by taking a use case where a paper document having an irregular size is inserted into a paper document having a regular size as an example, a method different from the above-described method for inserting an image obtained by a scan into another image obtained by another scan, and which can be performed more easily is introduced as an example.

### <Scanned Image Obtaining Processing Sequence>

First, the processing to obtain a scanned image in the present embodiment is explained. In the following, a flow of processing is explained, from transmitting a scanned image obtained by the image forming apparatus 100 performing a scan to the cloud service server 103 until the cloud service server 103 performs image processing.

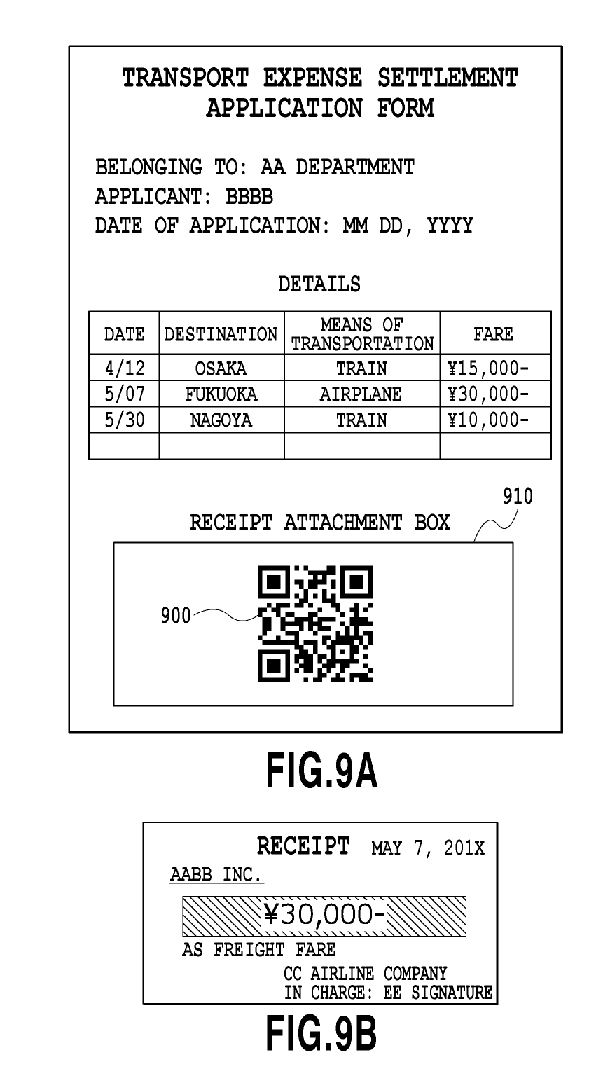

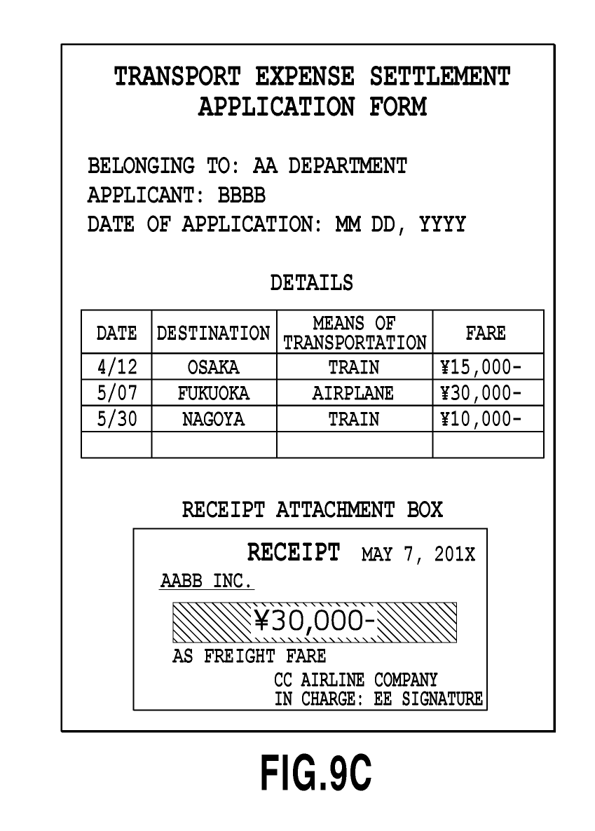

As an example of an image to be obtained, a scanned image obtained by scanning a regular size sheet as in FIG. 9A is used. First, in the image forming apparatus 100, processing is performed. At step S800, a user executes the scan application 500 by operating the operation unit 206 of the image forming apparatus 100 in order to perform a scan.

After the activation of the scan application 500, the screen display unit 501 of the scan application 500 produces a display to prompt the operation unit 206 to start a scan.

At step S801, upon receipt of instructions to start a scan from a user via the screen display unit 501, the scan application 500 gives instructions to perform a scan to the scan processing unit 502. The scan processing unit 502 obtains image data by driving the scanner unit 210 and generates a scanned image by using the image processing unit 503. The scan processing unit 502 stores the generated scanned image in the scanned data management unit 504.

At step S802, the image processing unit 503 of the scan application 500 performs image processing after obtaining a scanned image, such as filtering processing and color correction processing, on the scanned image generated at step S801. The scanned image after the image processing is stored in the scanned data management unit 504.

Next, at step S803, the communication unit 505 transmits the stored scanned image to the cloud service server 103.

Next, processing is performed in the cloud service server 103. At step S804, the image processing application 700 of the cloud service server 103 receives image data (scanned image) transmitted from the image forming apparatus 100. The scanned image data management unit of the cloud service server 103 stores the received scanned image.

At step S805, the image combining position determination unit 702 of the cloud service server 103 searches for a position where an image is combined with the scanned image. In order to make explanation specific, explanation is given with reference to FIG. 9A. In FIG. 9A, for example, a two-dimensional code 900 is embedded. In the present embodiment, a two-dimensional code is used as information indicative of a position of image combining. It is assumed that the two-dimensional code 900 includes a signal to the effect that “a captured image obtained from a camera is pasted to a separate sheet pasting surface”. In FIG. 9A, the separate sheet pasting surface refers to a receipt pasting box 910 in FIG. 9A.

In a case where the two-dimensional code 900 in FIG. 9A is detected, the image combining position determination unit 702 links an image (captured image in the present embodiment) to be combined to the combining position at step S805. In the above-described example, explanation is given based on the two-dimensional code, but the example is not limited to this and the combining position may be specified by another method. It may also be possible to specify a position where an image is combined by receiving, from a user, the specification of a region where the user desires to combine the image in the image forming apparatus 100 or the cloud service server 103.

At step S806, the scanned image information obtaining unit 706 of the cloud service server 103 obtains scanned image information by using a scanned image. For example, the scanned image information obtaining unit 706 obtains scanned image information, such as a histogram of the image, a result of chromatic/achromatic color pixel determination, an achromatic color pixel histogram, and MTF characteristics. The image processing application 700 of the cloud service server 103 makes adjustment so that the dynamic range of the scanned image becomes the same as that of the captured image at step S814, to be described later, based on the scanned image information obtained at step S806. The image processing application 700 of the cloud service server 103 stores the scanned image information in the HDD 304.

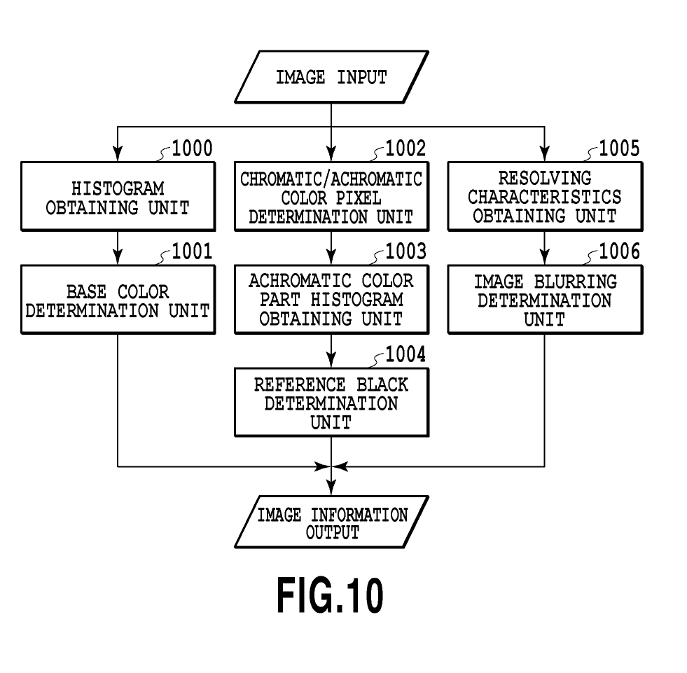

To make more specific the explanation of the processing to obtain scanned image information, explanation is given with reference to FIG. 10. FIG. 10 is a diagram showing an example of a configuration of the scanned image information obtaining unit 706. The scanned image information obtaining unit 706 has a histogram obtaining unit 1000, a base color determination unit 1001, a chromatic/achromatic color pixel determination unit 1002, an achromatic color part histogram obtaining unit 1003, and a reference black determination unit 1004. Further, the scanned image information obtaining unit 706 has a resolving characteristics obtaining unit 1005 and an image blurring determination unit 1006.

The histogram obtaining unit 1000 obtains a histogram of an image. The histogram obtaining unit 1000 obtains histograms corresponding to channels in a case of a color image or obtains a histogram corresponding to one channel in a case of a monochrome image. In order to achieve faster speed of processing, it is also possible to use a signal of one channel also for a color image, or to handle a plurality of channels as one channel by averaging the channels.

The base color determination unit 1001 determines the base color and the background color based on the histogram obtained by the histogram obtaining unit 1000. For example, in a case of color data in the RGB color space, the chromatic/achromatic color pixel determination unit 1002 converts the color space into the L*a*b* color space for each pixel and determines whether the color is a chromatic color or an achromatic color from the value of a color difference. The achromatic color part histogram obtaining unit 1003 obtains a histogram of the achromatic color pixel of the pixels determined by the chromatic/achromatic color pixel determination unit 1002. The reference black determination unit 1004 obtains the blackest signal value from the histogram of the achromatic color pixel obtained by the achromatic color part histogram obtaining unit 1003 and determines reference black. The resolving characteristics obtaining unit 1005 measures the MTF (Modulation Transfer Function) etc. in the image and obtains the resolving power within the image. The image blurring determination unit 1006 determines the degree of blurring of the image based on information on the resolving power of the image obtained by the resolving characteristics obtaining unit 1005.

In the manner such as described above, the cloud service server 103 obtains scanned image information. Next, at step S807 in FIG. 8, the image processing application 700 of the cloud service server 103 returns the image upload results to the image forming apparatus 100 as a response to step S802.

### <Captured Image Obtaining Processing Sequence>

Next, the processing to obtain a captured image in the present embodiment is explained. In the following, a flow of processing is explained, from transmitting a captured image obtained by performing image capturing at the mobile terminal 106 to the cloud service server 103 until the cloud service server 103 performs image processing.

As an example of an image to be obtained, it is assumed that a captured image obtained by capturing an image of an irregular size sheet as in FIG. 9B is used.

A flow of the processing to obtain a captured image is explained by using a sequence chart in FIG. 8. At step S808, first, a user executes the image capturing application 600 by operating the touch panel unit 406 of the mobile terminal 106 in order to perform image capturing.

After the activation of the image capturing application 600, the screen display unit 601 of the image capturing application 600 produces a display to prompt the start of image capturing on the touch panel unit 406.

Upon receipt of instructions to start image capturing from the screen display unit 601, the image capturing application 600 gives instructions to perform image capturing to the camera processing unit 602. The camera processing unit 602 obtains image data by driving the camera unit 408. The image processing unit 603 generates a captured image by using the image data obtained by the camera processing unit 602. The captured image data management unit 604 stores the generated captured image.

At step S810, the image processing unit 603 performs image processing after obtaining the captured image, such as filtering processing, color correction processing, and dynamic range adjustment, on the captured image generated at step S809. At step S810, it may also be possible for the image processing unit 603 to perform processing, such as trimming processing to remove unnecessary portions of the captured image, projection conversion, and trapezoid correction. The processing such as this may be performed within the cloud service server 103 after the communication unit 605 transmits the captured image to the cloud service server 103.

Next, at step S811, the communication unit 605 transmits the stored captured image to the cloud service server 103 by using the wireless communication unit 410.

Next, the processing moves to the processing by the cloud service server 103. At step S812, the image processing application 700 of the cloud service server 103 receives image data (captured image) transmitted from the mobile terminal 106 and stores the captured image by using the captured image data management unit 704.

At step S813, the captured image information obtaining unit 707 of the image processing application 700 obtains captured image information, such as a histogram of the captured image, a result of chromatic/achromatic color pixel determination, an achromatic color pixel histogram, and MTF characteristics. Based on the captured image information obtained at step S813, at step S814, to be described later, adjustment is made so that the dynamic range will be the same as that of the scanned image. The captured image information obtaining unit 707 stores the obtained captured image information in the HDD 304. The method for obtaining captured image information may be the same as that in FIG. 10 explained at step S806. In other words, the captured image information obtaining unit 707 may have the same configuration as that of the scanned image information obtaining unit.

### <Image Processing Sequence>

By still using FIG. 8, image processing of each of a scanned image and a captured image in the present embodiment is explained. In the following, a flow of performing image processing based on scanned image information and captured image information and integrating a scanned image and a captured image is explained. Captured image information and scanned image information can also be called first image information and second image information.

At step S814, the image processing unit 705 of the cloud service server 103 performs processing to match the features of a scanned image and a captured image based on the scanned image information and the captured image information. In other words, the image processing unit 705 performs correction to match the features of the scanned image and those of the captured image based on the histogram, the chromatic/achromatic color pixel determination results, the achromatic color pixel histogram, the MTF characteristics, etc., included in the scanned image information and the captured image information. As a specific example of the correction to match the features of the images, mention is made of the processing to match the dynamic range of a captured image with the dynamic range of a scanned image. Further, mention is made of the processing to match the reference black of the black color of the achromatic color represented by the character part of a captured image with reference to the reference black of a scanned image because it is difficult to determine reference black in a case of a captured image obtained via a camera. Furthermore, mention is made of the filtering processing in which the MFT characteristics of a scanned image and a captured image, respectively, are obtained and in a case where the resolving power is low, for example, an edge enhancement filter etc. is used. Still furthermore, mention is made of the shadow removal processing to determine a threshold value, based on which the influence by shadow etc. captured in a captured image at the time of image capturing by a camera is removed, based on the background color of a scanned image.

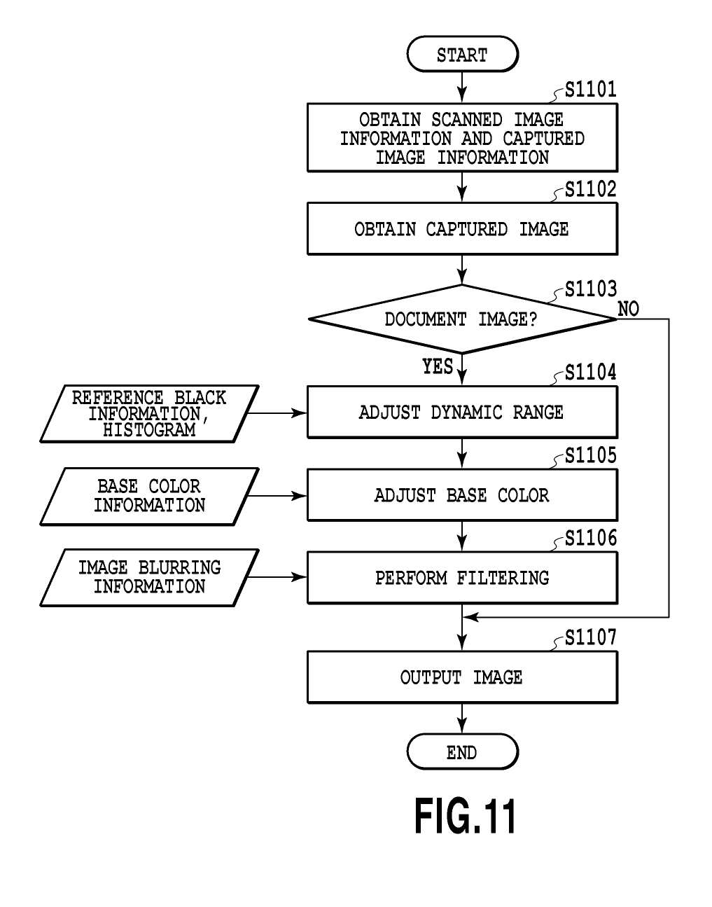

To more specifically explain the processing by the image processing unit 705 at step S814, explanation is given by using FIG. 11. In the present embodiment, an example is described in which a scanned image is taken as a reference and the characteristics of the images are matched by correcting a captured image, but the example is not limited to this and it is also possible to perform processing to correct a scanned image with a captured image being taken as a reference or to correct both images.

FIG. 11 is a flowchart showing an example of the processing by the image processing unit 705 of the cloud service server 103 at step S814.

At step S1101, the image processing unit 705 obtains scanned image information and captured image information. At step S1102, the image processing unit 705 obtains an image to be corrected. As explained previously, in the present embodiment, the processing to correct a captured image with a scanned image being taken as a reference is explained, and therefore, at step S1102, a captured image to be corrected is obtained.

At step S1103, the image processing unit 705 determines whether the captured image obtained at step S1102 is a character- or text-based document image, or a photo, or a natural image. For example, the image processing unit 705 determines whether or not the captured image is a character-based image by referring to the edge feature amount of a block in a predetermined range in the captured image. In a case where it is determined that the captured image is not a document image, the image processing unit 705 exits the processing. The reason for this is that there is a possibility that making histogram adjustment in accordance with the scanned image will break the tone of a photo, a natural image, etc. In a case where it is determined that the captured image is a document image, the image processing unit 705 proceeds the processing to step S1104.

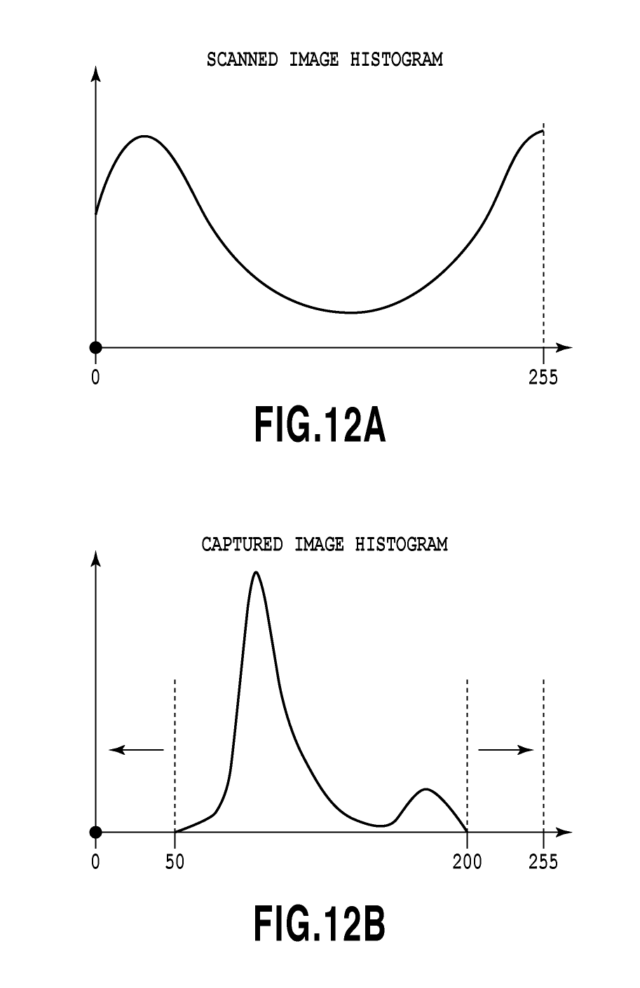

At step S1104, the image processing unit 705 adjusts the dynamic range of the captured image obtained at step S1102. Specifically, the image processing unit 705 corrects the reference black of the captured image by using information on the reference black included in the scanned image information. Further, the image processing unit 705 makes histogram adjustment of the captured image by using information on the histogram included in the scanned image information and information on the histogram included in the captured image information. For more detailed explanation, explanation is given by using FIG. 12A and FIG. 12B. FIG. 12A shows an image of a histogram obtained from an 8-bit scanned image. FIG. 12B shows an image of a histogram obtained from an 8-bit captured image. The tone range of the captured image in FIG. 12B is 50 to 200. The captured image in FIG. 12B is an 8-bit image, and therefore, the tone may take a value from 0 to 255. However, in the example in FIG. 12B, the range of the tone region is 50 to 200 and it is known that the tone region is narrow. In a case where the captured image is inserted into the scanned image in this state, the white portion of the scanned image can be reproduced as white and the black portion as black, but the captured image will be gray as a whole and both the white portion and the black portion will be gray, and therefore, the color tones do not match with each other. Because of this, by widening the tone region of the histogram of the captured image shown in FIG. 12B so as to be equivalent to that of the scanned image in FIG. 12A, it is made possible to insert the captured image into the scanned image with the color tones of the scanned image and the captured image being matched.

Next, at step S1105, the image processing unit 705 performs processing to adjust the base color. The image processing unit 705 determines the base color of the captured image from base color information included in the scanned image information and base color information included in the captured image information and removes the base color and performs tone curve correction.

Next, at step S1106, the image processing unit 705 performs filtering processing on the captured image based on image blurring information included in the scanned image information and image blurring information included in the captured image information. The image processing unit 705 performs filtering by using an edge enhancement filter in a case where the captured image is more blurred than the scanned image or by using a smoothing filter in a case where the captured image is too sharp on the contrary.

Next, at step S1107, the image processing unit 705 outputs the corrected image in a case where correction is performed at step S1104 to step S1106 or outputs the image obtained at step S1102 in a case where correction is not performed.

The above is the explanation of the image processing at step S814. Next, returning to FIG. 8 and the rest of the total processing sequence is explained.

At step S815, the image processing application 700 of the cloud service server 103 stores the corrected image in the HDD 304.

At step S816, the image combining unit 708 of the cloud service server 103 performs processing to combine the scanned image and the corrected captured image. Specifically, the corrected captured image is inserted into the combining position within the scanned image determined at step S805. By the processing at step S816, a document as shown in FIG. 9C is completed.

At step S817, the image processing application 700 returns the image upload results to the mobile terminal 106 as a response to step S811.

### <Image Browsing Sequence>

Finally, browsing of the image as the result of combining the scanned image and the captured image in the present embodiment is explained. Here, an example in which browsing is performed by using the mobile terminal 106 is introduced, but the example is not limited to this and it is possible to perform browsing by, for example, the PC 101 connected to the LAN 105. Besides this, it is also possible to produce a printout of a combined image in a case of an MFP, such as the image forming apparatus 100.

At step S818, the Web browser 606 of the mobile terminal 106 accesses a specific URL (Uniform Resource Locator) on the cloud service server 103. The URL indicates a home page in which images stored in the cloud service server 103 are browsed and for example, the URL may be notified to the mobile terminal 106 in the response of the image upload at step S817.

At step S819, to the Web browser 606, information on the URL in which images can be browsed is returned from the cloud service server 103 as a response to the request to check images.

At step S820, the Web browser 606 browses the integrated image by accessing the URL returned at step S819.

By performing the above processing, it is made possible to match the dynamic ranges, color tones, and base colors at the time of combining images obtained by different devices or inserting an image into another. In the present embodiment, explanation is given by using the example in which the captured image is corrected in a case where the scanned image and the captured image obtained by a camera are integrated, but the example is not limited to this. For example, it is also possible to perform the same processing on data of generated text generated by a PC and a captured image, or on data of generated text of a PC and a scanned image, or on data of generated text of a PC, scanned image and captured image.

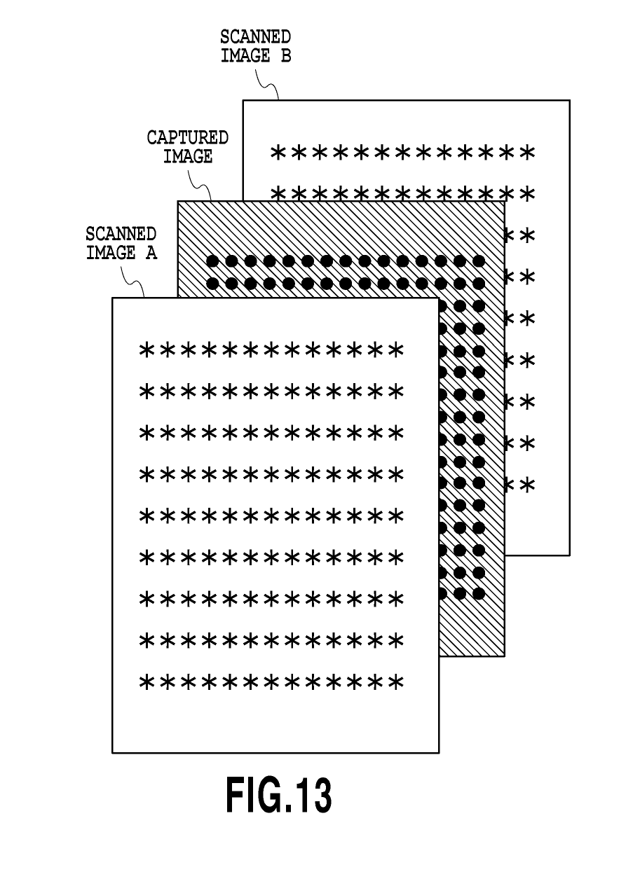

Further, in the present embodiment, the example is described in which an image obtained from another device is combined within one image, but the example is not limited to this and it is also possible to perform the processing in a case where an image is inserted between pages, for example, as shown in FIG. 13. It is also possible to apply the processing in a case where an image captured by a camera is inserted between a scanned image A and a scanned image B to form one file, for example, as shown in FIG. 13. In this case, as correction of the captured image, it may also be possible to correct the captured image by reading histograms etc. from the scanned image A and the scanned image B before and after the captured image.

### Second Embodiment

In the first embodiment, the method for matching the dynamic ranges, color tones, and base colors by obtaining histograms etc. from whole images in a case where images obtained by different devices are combined or one image is inserted into another is explained. However, in a case where correction is performed by simply determining dynamic ranges etc. from whole images, if a plurality of attributes exists, adjustment is made in accordance with the features of a different attribute. For example, a case is supposed where an image of document text captured by a camera (captured image) partially includes a photo attribute region. For example, in a case where the captured image is corrected so as to match with a scanned image in accordance with the method in the first embodiment, the dynamic range and the histogram are determined from the image of the document obtained by a scanner (scanned image). Because of this, the character attribute portion of the captured image is corrected as desired, but there is a possibility that the photo attribute portion will lose the tone properties.

Consequently, in the second embodiment, an example is explained in which processing to determine an attribute, such as a character attribute and a photo attribute, is incorporated in the processing of obtaining information, such as a histogram, and in the processing of performing image correction in accordance with the information, and histogram adjustment etc. is made for each attribute.

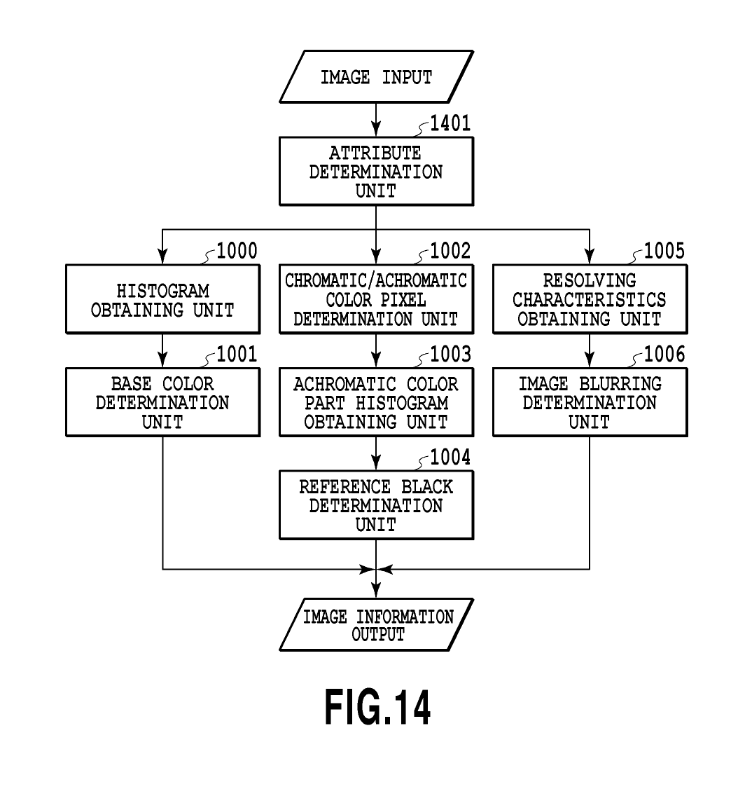

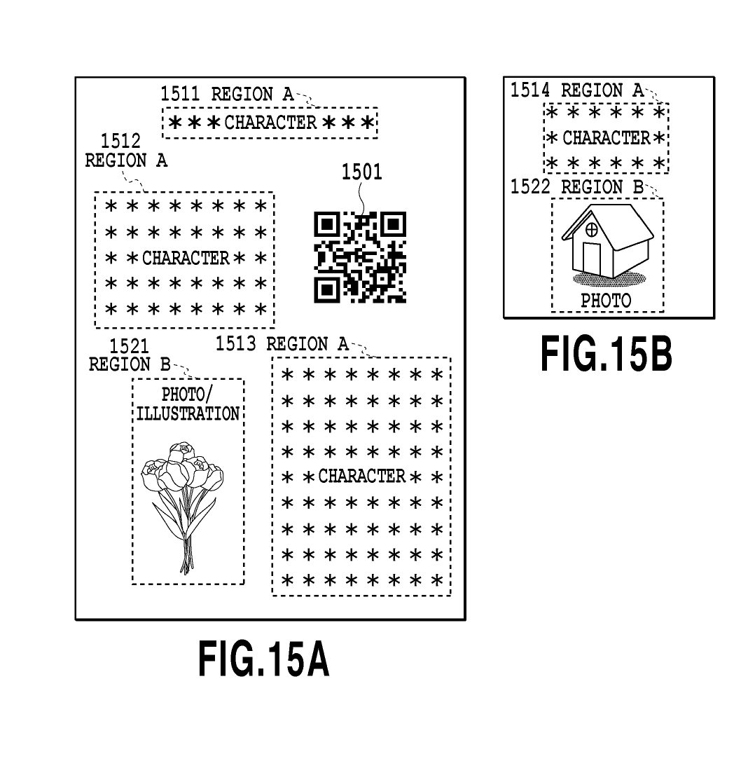

FIG. 14 is a diagram showing an example of a configuration of an image information obtaining unit, such as a scanned image information obtaining unit and a captured image information obtaining unit. In FIG. 14, to the same component as the component shown in FIG. 10 described above, the same reference numeral is attached. The image information obtaining unit in FIG. 14 further includes an attribute determination unit 1401 in addition to the configuration shown in FIG. 10. The attribute determination unit 1401 determines an attribute of an input image. In order to make explanation more specific, explanation is given by using FIG. 15A and FIG. 15B. FIG. 15A is a diagram showing an example of a scanned image obtained by a scanner of the image forming apparatus 100. FIG. 15B is a diagram showing an example of a captured image obtained by the mobile terminal 106. In the present embodiment, the attribute determination unit 1401 determines attributes of the scanned image and the captured image. For example, the attribute determination unit 1401 determines a region of the character portion and a region of the non-character portion, respectively, of the obtained scanned image and captured image.

In the examples in FIG. 15A and FIG. 15B, regions A 1511 to 1514 are regions corresponding to the character portion and regions B 1521 and 1522 are regions of the non-character portion including a photo or an illustration other than characters. In the present embodiment, the regions are classified according to attribute and the processing to obtain information on the image, such as a histogram, explained in FIG. 10 from within the same attribute region is performed on each image. By the processing shown in FIG. 14, characteristics of the regions having the same attribute are obtained from the regions determined by the attribute determination unit 1401.

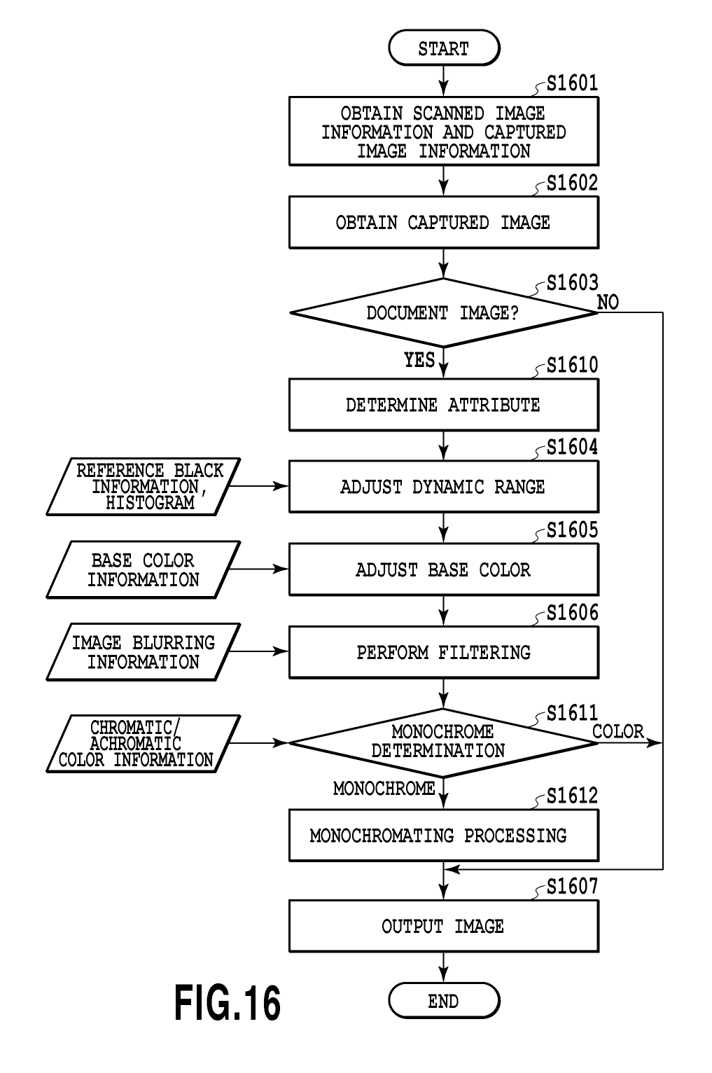

FIG. 16 is a flowchart showing an example of a flow of image processing in the second embodiment. In FIG. 16, the processing at step S1601 to step S1606 may be the same as that at step S1101 to step S1106 in FIG. 11, and therefore, explanation is omitted. In the present embodiment, attribute determination processing at step S1610, monochrome determination processing at step S1611, and monochromating processing at step S1612 are added to the processing in FIG. 11.

At step S1603, the image processing unit 705 determines whether or not a captured image is a document image and in a case where it is determined that the captured image is a document image, the processing is caused to proceed to step S1610. At step S1610, the image processing unit 705 determines attributes of objects as explained in FIG. 14. The image processing unit 705 determines, for example, whether the region is a character attribute region or a non-character (photo or illustration) attribute region. For example, the image processing unit 705 determines whether or not the region is a character attribute region by referring to the edge feature amount of a block in a predetermined range in the capture image. Then, the processing at step S1604 to step S1606 is performed for each attribute. In other words, for the character attribute region of the captured image, the processing at step S1604 to step S1606 is performed by using captured image information of the character attribute region of the captured image and scanned image information of the character attribute region of the scanned image.

The processing at step S1603 and that at step S1610 may be put together into one piece of processing as common processing to determine whether or not the attribute is a character. For example, the image processing unit 705 determines all the pixels based on the edge feature amount in a predetermined range of the captured image. In a case where it is determined that no character region is included in the captured image as the result of the determination, the processing is caused to proceed to processing in a case of NO at step S1603. In a case where a character region is included even though partially, the image processing unit 705 performs the processing at step S1604 to step S1606 on the character region of the captured image by using information on the character region in the captured image and information on the character region in the scanned image information.

In the examples in FIG. 15A and FIG. 15B, it is assumed that the processing to insert the captured image in FIG. 15B at the position where a two-dimensional code 1501 is arranged in the scanned image shown in FIG. 15A is performed. In the image processing in this case, for example, for the region A 1514, which is a character region of the camera image in FIG. 15B, processing in accordance with image information on the region and image information on regions A 1511 to 1513, which are character regions in the scanned image in FIG. 15A, is performed. On the other hand, for the region B 1522, which is a non-character region in the captured image in FIG. 15B, processing in accordance with image information on the region and image information on the region B 1521 in the captured image in FIG. 15A is performed.

Next, at step S1604 to step S1606, the same processing as that explained in FIG. 11 is performed for the region of each attribute. As an option, it may also be possible to perform the processing at step S1611 and step S1612. In other words, it is also possible for the image processing unit 705 to obtain the chromatic color/achromatic color information included in the scanned image information and the captured image information, respectively, and to switch between color and monochrome for each attribute. For example, in a case where the character regions A 1511 to 1513 in the scanned image shown in FIG. 15A have an achromatic color, it is also possible to insert the character region A 1514 in the captured image shown in FIG. 15B, which is to be inserted, after turning the character region also into an achromatic color region. In this case, at step S1611, the image processing unit 705 performs monochrome determination based on the chromatic/achromatic color information. The monochrome determination is determination to determine that the region of the first attribute in the captured image to be corrected is monochrome in a case where the region of the first attribute in the scanned image, which is a reference of image correction, is monochrome. In a case where regions of a plurality of attributes are included, the determination is performed for each attribute. In a case where it is determined that the region is monochrome as the result of step S1611, the image processing unit 705 performs monochromating processing at step S1612. The determination at step S1611 may be automatic determination as described above or may be processing based on instructions by a user. In a case where the number of achromatic color regions is large in the region in the image, which is a reference of image correction, processing to turn a region into an achromatic color region may be performed even in a case where an image to be corrected is a chromatic color document and the example is not limited to the above-described example of the combination.

By performing the above processing, it is made possible to adjust differences in color tone between devices, the dynamic ranges, and colors without destroying tone in the portions other than characters also in a case where an attribute other than the character attribute exists within an image.

### Third Embodiment

In the first embodiment and the second embodiment, the method for correcting an image based on obtained image information by obtaining image information, such as a histogram, from the image itself, such as a scanned image and a captured image, is explained. However, there is a limit to the image information that can be obtained from the images themselves. In order to bring the image quality of an image obtained by a first device close to that of an image obtained by a second device, the presence of information on the devices used to obtain the images will make the method more effective.

Consequently, in a third embodiment, a configuration is explained, which will make it possible to perform correction to obtain equivalent image quality by storing device information on devices used to obtain images within the cloud service server and by performing correction by further using the stored device information.

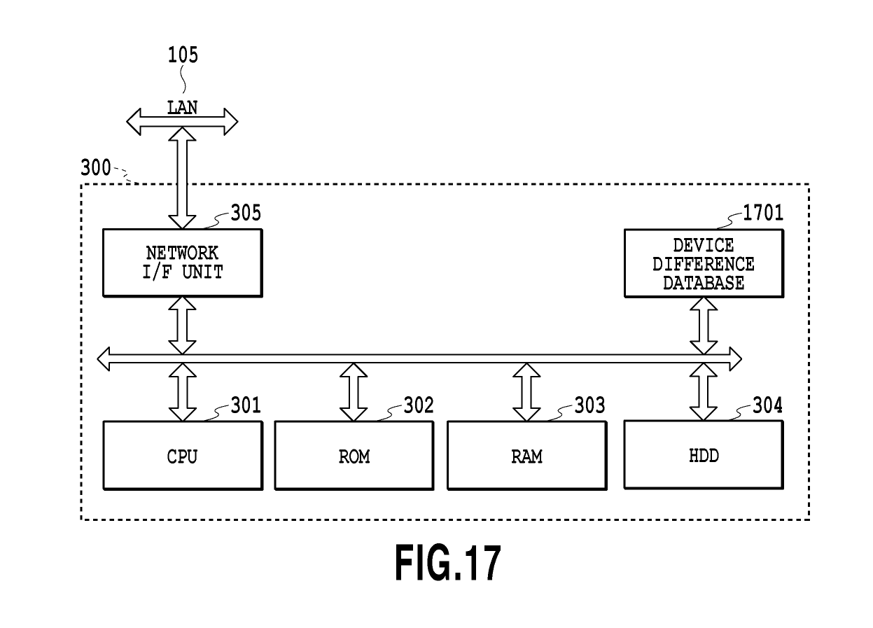

FIG. 17 is a diagram showing an example of a configuration of a cloud service server in the third embodiment. In FIG. 17, the same reference numerals are attached to the same components as those in the configuration shown in FIG. 3 described above. FIG. 17 includes a device difference database 1701 in addition to the configuration shown in FIG. 3.

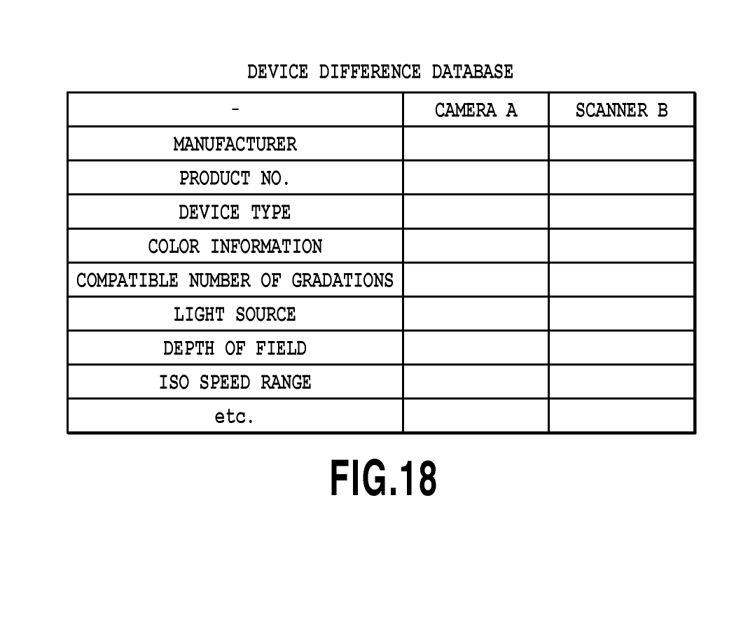

FIG. 18 is a diagram showing an example of information stored in the device difference database 1701. Within the device difference database 1701, various kinds of information on devices that can be input and device characteristics are stored in the form of a table. As the table, a table storing differences between devices or a table storing specifications of devices as absolute values may be accepted. As the contents to be stored, mention is made, for example, of the device type, such as a scanner and a camera, associated with the product number, color information, such as reproducible color regions of devices, and the compatible number of tones. Further, those related to device inputs are stored, for example, a light source, such as a white LED, and the color temperature thereof in a case of a scanner, or an ISO speed range etc. in a case of a camera. Further, as differences between devices, a difference between reproducible color regions etc. is stored and the difference is stored in the device difference database 1701 in the form of a table.

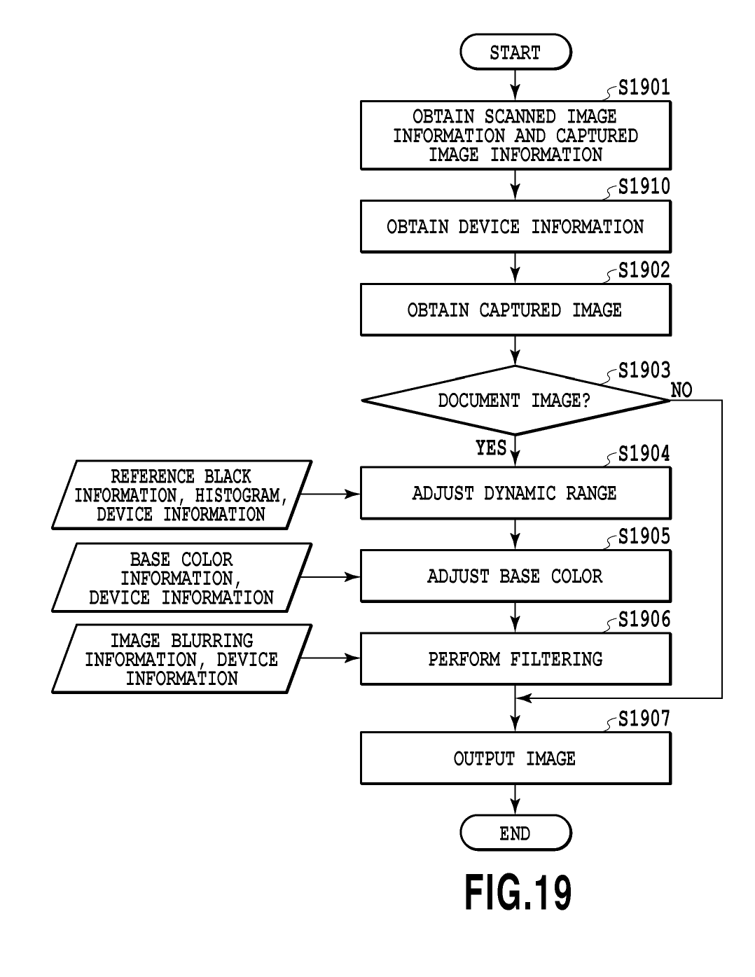

FIG. 19 is a flowchart showing an example of a flow of image processing in the third embodiment which uses the device difference database 1701. The processing at step S1901 is the same as that at step S1101 in FIG. 11. At step S1910, the image processing unit 705 obtains device information on devices having obtained a scanned image and a captured image used to obtain the scanned image information and the captured image information obtained at step S1901. For example, the image processing unit 705 searches a device difference database based on information specifying devices included in the scanned image information and the captured image information and obtains various kinds of information on the devices and device characteristics. In the present embodiment, it is assumed that the general term of the various kinds of information on devices and device characteristics as shown in FIG. 18 is device information. At subsequent steps S1904 to S1906, the image processing unit 705 performs each piece of the processing by further using the device information obtained at step S1910. For example, in dynamic range adjustment processing at step S1904, the image processing unit 705 adjusts the dynamic ranges and specifies reference black by using color information, such as a reproducible color range, and information on the light source included in the device information. For example, in a case where both the scanned image and the captured images are dark, the images remain still dark even in a case where one of the dynamic ranges is adjusted to the other, but by using the device information, it is made possible to correct the image into a bright image.

As explained above, not only by obtaining information, such as histograms, from images obtained from devices but also by using various kinds of information on the devices and the device characteristics, it is made possible to improve accuracy of adjustment of color tones and image qualities between images.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment (s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-242152, filed Nov. 22, 2013, which is hereby incorporated by reference herein in its entirety.

What is claimed is:

1. An image processing apparatus comprising:
an obtaining unit configured to obtain first image information indicative of characteristics of a first image obtained from a first device and second image information indicative of characteristics of a second image obtained from a second device that is a device different from the first device;
a correction unit configured to correct the first image based on the first image information and the second image information; and
a combination unit configured to combine the first image corrected by the correction unit and the second image.

2. The image processing apparatus according to claim 1, further comprising a determination unit configured to determine whether the first image is a document image, wherein
in a case where the determination unit determines that the first image is a document image, the correction unit corrects the first image.

3. The image processing apparatus according to claim 1, wherein
the obtaining unit obtains first image information and second image information indicative of characteristics of each attribute region, and
the correction unit corrects the first image for each attribute region based on the first image information and the second image information indicative of the characteristics of the each attribute region.

4. The image processing apparatus according to claim 1, further comprising a unit configured to monochromate, in a case where a first attribute region included in the first image is a color image and a region with the same attribute as that of the first attribute region included in the second image is a monochrome image, the first attribute region of the first image.

5. The image processing apparatus according to claim 1, wherein
the obtaining unit obtains device information on the first device and device information on the second device, and
the correction unit corrects the first image further based on the device information.

6. The image processing apparatus according to claim 1, wherein
the correction unit corrects a dynamic range of the first image based on a histogram included in the first image information and reference black and a histogram included in the second image information.

7. The image processing apparatus according to claim 1, wherein
the correction unit corrects a base color of the first image based on base color information included in the first image information and base color information included in the second image information.

8. The image processing apparatus according to claim 1, wherein
the correction unit performs filtering on the first image based on image blurring information included in the first image information and image blurring information included in the second image information.

9. The image processing apparatus according to claim 1, wherein
the first device is a device including an image capturing unit and the second device is a device including a reading unit.

10. The image processing apparatus according to claim 1, wherein
the correction unit corrects the second image in addition to the first image.

11. An image processing method comprising the steps of:
obtaining first image information indicative of characteristics of a first image obtained from a first device and second image information indicative of characteristics of a second image obtained from a second device that is a device different from the first device;
correcting the first image based on the first image information and the second image information; and
combining the first image corrected in the correction step and the second image.

12. A non-transitory computer readable storage medium storing a program which causes a computer to perform the image processing method according to claim 11.
